(19) United States
(12) Patent Application Publication
(10) Pub. No.: US 2026/0001332 A1
(43) Pub. Date: Jan. 1, 2026

(54) PRINTING APPARATUS

(71) Applicant: CANON KABUSHIKI KAISHA, Tokyo (JP)

(72) Inventor: KAZUYA KOIZUMI, Tokyo (JP)

(21) Appl. No.: 19/247,042

(22) Filed: Jun. 24, 2025

(30) Foreign Application Priority Data
Jun. 26, 2024 (JP) 2024-103283

(51) Int. Cl. B41J 2/17; B41J 2/175

(52) U.S. Cl. CPC B41J 2/1714; B41J 2/17566

(57) ABSTRACT

A printing apparatus includes a discharging unit configured to discharge a liquid to a print medium, a suction unit configured to suck mist on the print medium, an acquiring unit configured to acquire information about a distance between the print medium and the discharging unit, and a suction control unit configured to control driving of the suction unit based on the information acquired by the acquiring unit. The suction control unit is configured to control presence/absence of driving of the suction unit based on the information.

### BACKGROUND

### Cross Reference to Priority Application

This application claims the benefit of Japanese Patent Application No. 2024-103283, filed Jun. 26, 2024, which is hereby incorporated by reference herein in its entirety.

### FIELD OF THE TECHNOLOGY

The present disclosure relates to a printing apparatus.

### DESCRIPTION OF THE RELATED ART

In a printing apparatus that prints an image by discharging ink to a print medium, a gap exists between the print medium and a discharge head that discharges the ink. The ink discharged from the discharge head flies through the gap and lands on the print medium. Not all the ink discharged from the discharge head necessarily lands on the print medium, and ink particles that are called mist and are not associated with printing are sometimes generated. Such mist may make the print medium or the printing apparatus dirty. Japanese Patent Laid-Open No. 2004-284067 proposes a technique of sucking mist and preventing it from scattering.

In Japanese Patent Laid-Open No. 2004-284067, to reduce the energy consumption of a printing apparatus, the mist suction amount is controlled in accordance with a printing area ratio. However, there is room for improvement in terms of preventing mist from sticking to the periphery and reducing the energy consumption of the printing apparatus.

### SUMMARY

The present disclosure provides a technique of preventing mist from sticking to the periphery and reducing energy consumption.

According to one aspect of the present disclosure, there is provided a printing apparatus comprising: a discharging unit configured to discharge a liquid to a print medium; a suction unit configured to suck mist on the print medium; an acquiring unit configured to acquire information about a distance between the print medium and the discharging unit; and a suction control unit configured to control driving of the suction unit based on the information acquired by the acquiring unit, wherein the suction control unit is configured to control presence/absence of driving of the suction unit based on the information.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing the outer appearance of a printing apparatus according to the embodiment of the present disclosure;

FIG. 2 is an explanatory view of a printing mechanism and a suction unit of the printing apparatus shown in FIG. 1;

FIG. 3 is a view showing the positional relationship between a carriage, a discharge head, a print medium, and a platen;

FIG. 4 is an explanatory view showing an example of a changing unit;

FIG. 5 is an explanatory view showing an example of a changing unit;

FIG. 6 shows views showing the shape of a lift cam and the relationship between a rotation angle and a lift amount;

FIG. 7 is a block diagram of a control circuit of the printing apparatus shown in FIG. 1;

FIG. 8 is a flowchart showing an example of processing of the control circuit;

FIG. 9 is a view showing an example of the correspondence relationship between print conditions and types of print processing;

FIG. 10 is a flowchart showing an example of suctionless print processing;

FIG. 11 is a flowchart showing an example of mist suction print processing;

FIG. 12 is a view showing an example of the relationship between a temperature/humidity and regions A to C for discriminating a distance HP; and

FIG. 13 is a view showing an example of the relationship between the distance HP and an air quantity.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <Outline of Printing Apparatus>

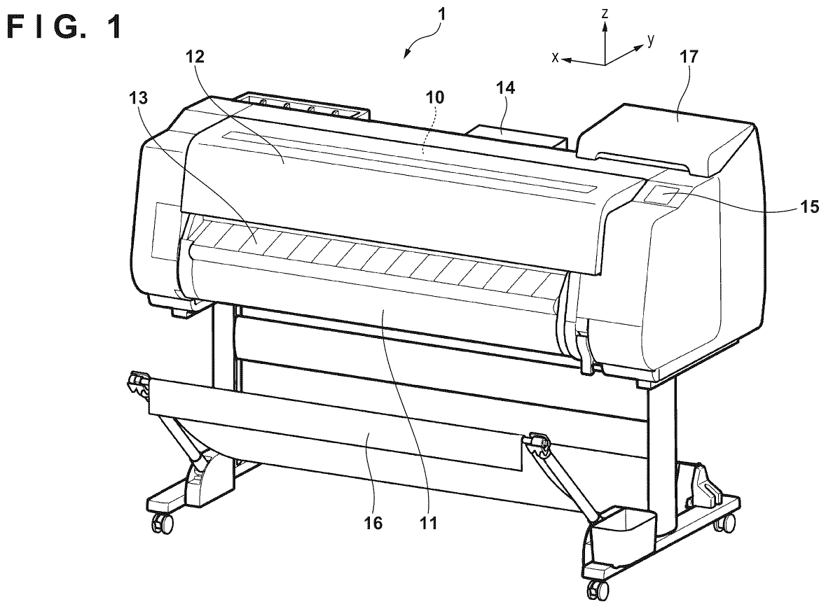

FIG. 1 is a view showing the outer appearance of a printing apparatus 1 according to the embodiment of the present disclosure. In the drawings, arrows X, Y, and Z indicate directions crossing each other. In this embodiment, the arrows X and Y indicate horizontal directions crossing each other and show the widthwise direction and the depth direction of the printing apparatus 1, and the arrow Z indicates the up/down direction (height direction).

The printing apparatus 1 according to this embodiment is an inkjet printing apparatus that discharges ink that is a liquid to a print medium and thus prints an image on the print medium. In this embodiment, a case where the present disclosure is applied to a serial type inkjet printing apparatus will be described, but the present disclosure can also be applied to a printing apparatus of another type.

Also, “print” includes not only forming significant information such as characters and graphics but also forming images, figures, patterns, and the like on print media in a broad sense, or processing print media, regardless of whether the information formed is significant or insignificant or whether the information formed is visualized so that a human can visually perceive it. In addition, although in this embodiment, sheet-like paper is assumed as a “print medium”, cloth, a plastic film, and the like may also be used. The printing apparatus 1 can print a plurality of types of print media having different widths, and can print a print medium having a size of, for example, 60 inches at maximum. As the print medium, roll paper or cut paper can be used.

The printing apparatus 1 includes a holder 11 that holds roll paper as a print medium. On the roll paper supplied from the holder 11, an image is printed by a printing mechanism 10 covered with a top cover 12. Also, the printing apparatus 1 includes a tray (not shown) that introduces cut paper into the apparatus, and the printing mechanism 10 can print an image on the cut paper.

Ink to be consumed by the printing mechanism 10 is stored in a tank unit 17. The tank unit 17 stores a plurality of ink tanks in which inks with colors of black, cyan, magenta, yellow, and the like are stored. The roll paper with the image printed thereon is discharged from a discharge port 13 to the outside of the apparatus. The discharged roll paper is stacked on a guide 16.

On the rear portion of the printing apparatus 1, a suction unit 14 configured to suck ink mist generated on the print medium during printing in the printing mechanism 10 and discharge it from above the print medium is provided. The printing apparatus 1 also includes an operation display unit 15 as a user interface. The operation display unit 15 is formed by, for example, a touch panel. The operation display unit 15 displays various kinds of print information and setting results and also accepts various kinds of settings such as print conditions from a user.

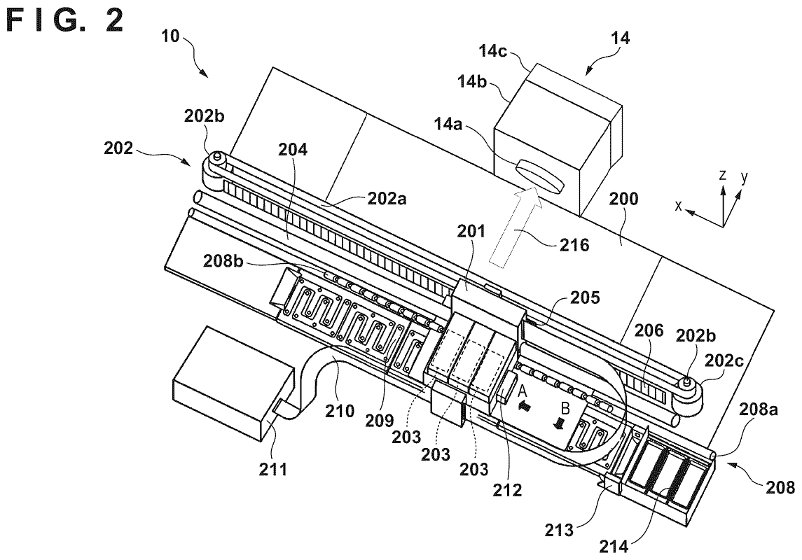

FIG. 2 is an explanatory view of the printing mechanism 10 and the suction unit 14. The printing mechanism 10 includes a carriage 201 capable of reciprocally moving in the widthwise direction (the direction of an arrow A, which is the X direction or the main scanning direction) of the print medium 200, and a conveyance unit 208 configured to convey the print medium 200 in the direction of an arrow B (the Y direction or the sub-scanning direction).

A plurality of discharge heads 203 are mounted on the carriage 201. Each discharge head 203 discharges a liquid. In this embodiment, each discharge head 203 is a printhead that discharges ink supplied from the tank unit 17 to the print medium 200 and prints an image. Each discharge head 203 is arranged facing a platen 209. The ink is discharged from a discharge surface on the lower surface of the discharge head 203 to the print medium 200 supported by the platen 209. In the discharge surface, a plurality of orifices (nozzles) configured to discharge the ink are formed. Each nozzle is provided with, for example, an electrothermal transducer (heater), and the electrothermal transducer heats and foams the ink by energization and causes the nozzle to discharge the ink by the foaming energy.

The printing mechanism 10 also includes a moving mechanism 202 that reciprocally moves the carriage 201 in the direction A. Ink is discharged from each discharge head 203 to the print medium 200 in the moving process of the carriage 201, thereby printing an image. This operation is sometimes called print scanning.

In this embodiment, the moving mechanism 202 is a belt transmission mechanism. More specifically, the moving mechanism 202 includes two pulleys 202b arranged apart in the X direction, an endless belt 202a wound around the two pulleys 202b, and a carriage motor 202c that is a driving source for rotating the pulleys 202b. The carriage 201 is fixed to the endless belt 202a. When the carriage motor 202c is driven, the endless belt 202a travels, and the carriage 201 can be moved along a guide 204 extended in the X direction. The position of the carriage 201 can be detected by reading a linear scale 206 extended in the X direction by an encoder sensor 205 mounted on then carriage 201.

The carriage 201 is electrically connected to a main board 211 via a flexible flat cable (to be referred to as “FFC” hereinafter) 210. Power is supplied from the main board 211 to the discharge heads 203 via the FFC 210. Also, the main board 211 acquires the detection result of the encoder sensor 205 via the FFC 210.

The conveyance unit 208 is a mechanism that conveys the print medium 200 to between the discharge heads 203 and the platen 209, and includes a conveyance roller 208a extended in the X direction, and a conveyance motor (not shown) that is a driving source for rotating the conveyance roller 208a. A plurality of driven rollers 208b are in pressure contact with the conveyance roller 208a, and the print medium 200 is clamped by the nip portions therebetween. When the conveyance roller 208a rotates, the print medium 200 is intermittently conveyed to the discharge heads 203. A printing operation is performed by alternately repeating the conveyance operation of the print medium 200 by the conveyance unit 208 and print scanning.

When printing on the print medium 200 is ended, a cutting mechanism 213 cuts the print medium 200. Cutting of the print medium 200 can be selected by the operation display unit 15 or a host device such as a personal computer connected to the printing apparatus 1.

The suction unit 14 is arranged on the rear side of the carriage 201 in the Y direction, and ink mist generated by printing on the print medium 200 is sucked by the suction unit 14 in the direction of an arrow 216 and discharged from above the print medium 200. The suction unit 14 includes an electric fan 14a, a recovery unit 14b, and an exhaust port 14c. An airflow in the direction of the arrow 216 is generated by an electric fan 14a, and the ink mist is introduced into the recovery unit 14b. The recovery unit 14b includes a mist filter configured not to discharge the ink mist to the outside of the apparatus, and the ink mist is recovered by the recovery unit 14b. Air in which the ink mist is recovered is exhausted from the exhaust port 14c to the outside of the apparatus.

A maintenance unit 214 is arranged at one end portion of the moving range of the carriage 201. The maintenance unit 214 is arranged outside the print region (discharge region) of the discharge heads 203 and performs processing associated with recovery and maintaining of the discharge performance of the discharge heads 203. Examples of the processing are preliminary discharge in which a predetermined amount of ink not contributing to printing of an image is discharged before the printing operation and processing of sucking remaining ink or the like from the discharge port of the suction unit 14.

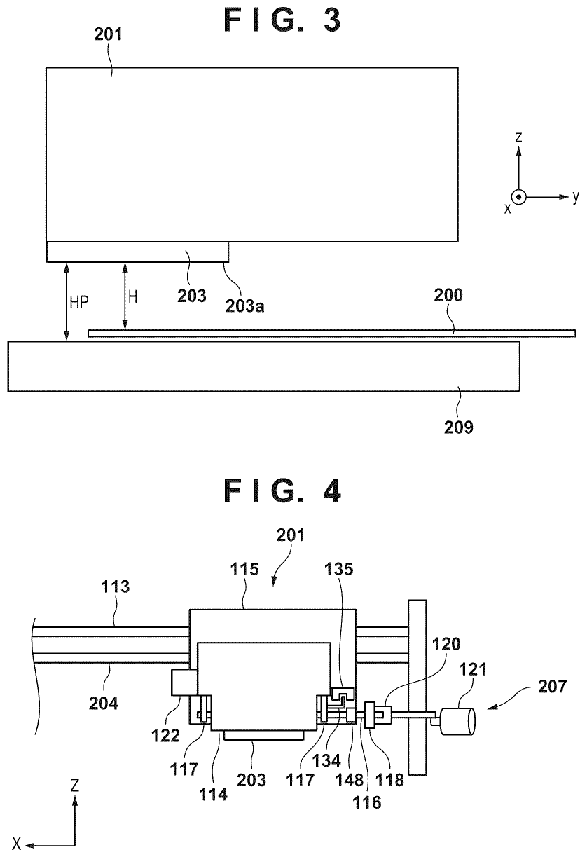

The printing apparatus 1 can include a changing unit capable of changing the height of the discharge head 203 (the height of the discharge surface) with respect to the platen 209. The height of the discharge head 203 with respect to the platen 209 is sometimes called a distance HP. FIG. 3 is a view showing the positional relationship between the carriage 201, the discharge head 203, the print medium 200, and the platen 209. In general, when a distance H between the print medium 200 and a discharge surface 203a of the discharge head 203 increases, the ink mist amount tends to be large. The distance H holds a relationship given by distance H=distance HP−thickness of print medium 200. When the height of the discharge head 203 is changed, the distance H also changes.

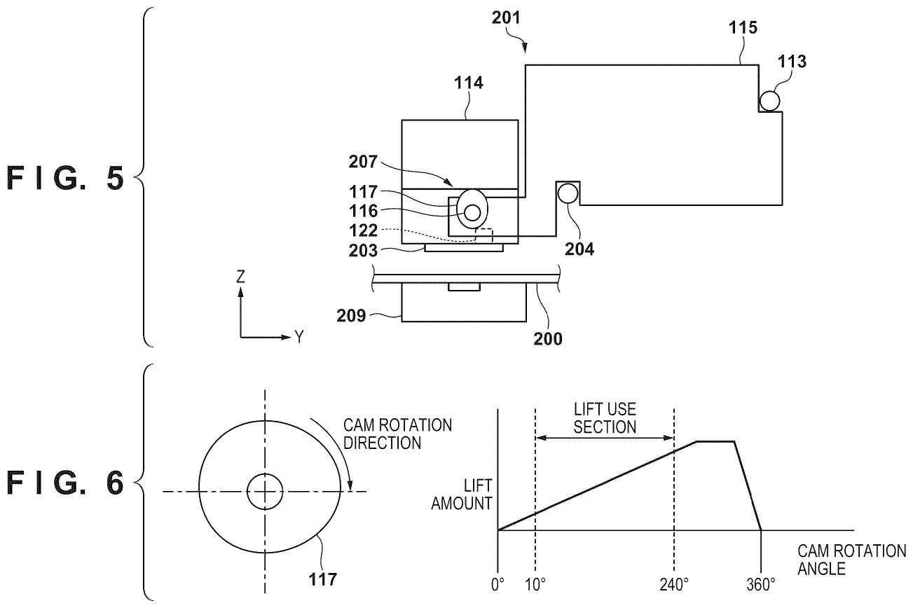

FIGS. 4 and 5 are explanatory views showing an example of a changing unit 207. The changing unit 207 includes a lift cam 117 and a lift motor 121 that drives the lift cam 117. The changing unit 207 is configured to adjust the distance HP in accordance with predetermined conditions such as the type and thickness of the print medium 200 and a print mode by moving the discharge head 203 up and down via the carriage 201. Note that it is the distance H that affects the landing accuracy of ink discharged from the discharge head 203. However, since the distance H is a distance obtained by removing the thickness of the print medium 200 from the distance HP, the distance H can substantially be adjusted by adjusting the distance HP.

The carriage 201 includes a main carriage 114 on which the discharge heads 203 are mounted, and a rear carriage 115 connected to the endless belt 202a. These are connected via a lift shaft 116 and the outer peripheral portion of the lift cam 117. An optical multisensor 122 having a plurality of measurement functions is mounted on the main carriage 114. The multisensor 122 can be configured to include optical components such as a light emitting element and a light receiving element. By the multisensor 122, the position of an end portion of the print medium 200, and the like can be detected.

A lift coupling 118 is provided at the end portion of the lift shaft 116. When the carriage 201 moves to a predetermined position along the guides 204 and 113, the lift coupling 118 is connected to a driving-side coupling 120. The driving-side coupling 120 is connected to the lift motor 121. When the lift motor 121 rotates in the CW direction in a state in which the lift coupling 118 and the driving-side coupling 120 are connected, the lift coupling 118, and the lift shaft 116 and the lift cam 117 which are connected to the lift coupling 118 rotate together.

FIG. 6 shows views showing the shape of the lift cam 117 and the relationship between the rotation angle and the lift amount of the lift cam 117. The lift cam 117 has an outer periphery with a smooth arc shape eccentric with respect to the lift shaft 116, and is supported by a cam support surface provided on the rear carriage 115. With this configuration, when the lift cam 117 is rotated by the lift motor 121, the cam support surface and the lift shaft 116 are moved closer or apart in accordance with the eccentricity amount and, therefore, the relative height of the main carriage 114 to the rear carriage 115 changes. The distance HP also changes accordingly.

In addition, the lift cam 117 is formed into such a shape that increases the eccentricity amount at the time of rotation in the CW direction (clockwise direction) in the rotation angle region of the lift use section. For this reason, if the angle of the lift cam 117 is controlled, the lift cam 117 is stopped at a predetermined angle, and if the angle can be maintained, the height of the discharge head 203 can freely be controlled.

Here, the outer periphery of the lift cam 117 and the cam support surface are configured to always have an angle. For this reason, even if the lift cam 117 is stopped at a predetermined rotation angle, it may be impossible to maintain the rotation angle and the lift cam 117 may rotate if a vibration or the like is applied from the outside. Hence, a one-way clutch 148 is attached to the lift shaft 116, and the lift shaft 116 rotates only in one direction (CW direction).

With this configuration, in the lift use section, rotation in the CW direction from a state in which the lift cam 117 is stopped at a certain rotation angle is rotation in a direction to increase the eccentricity amount of the lift cam 117. For this reason, to rotate the lift cam 117 from the stop state, a torque for raising the main carriage 114 is necessary, and rotation is impossible unless a driving force of a motor or the like exists. Also, rotation in the CCW direction (counterclockwise direction) is prevented by the one-way clutch 148. With this configuration, even if the lift cam 117 has a smooth outer periphery, rotation of the lift shaft 116 due to a vibration from the outside can be prevented.

On the lift cam 117, a flag 134 that displaces along with the rotation of the lift cam 117 is provided such that the phase (rotation angle) at the time of cam rotation can be known. The timing at which the flag 134 shields light from the light emitting element of a photosensor 135 provided on the side of the rear carriage 115 (ON time) or the state changes from light shielding to transmitting (OFF time) is the start point of the lift cam 117.

Angle control of the lift cam 117 is performed by rotationally driving the lift motor 121 by an arbitrary amount from the start point, that is, 0° set to the ON or OFF timing. For example, the lift motor 121 may incorporate an optical encoder, and its rotation angle may be detected at a high resolution. Then, the rotation angle of the lift cam 117 may be acquired based on the rotation angle of the lift motor 121. The rotation angle of the lift cam 117 is converted into the distance HP, and the distance HP is stored as distance information in, for example, a RAM 305 to be described later. Note that to detect the start point of the lift cam 117 or the rotation angle of the lift motor, a known technique can appropriately be employed.

### <Configuration of Control System>

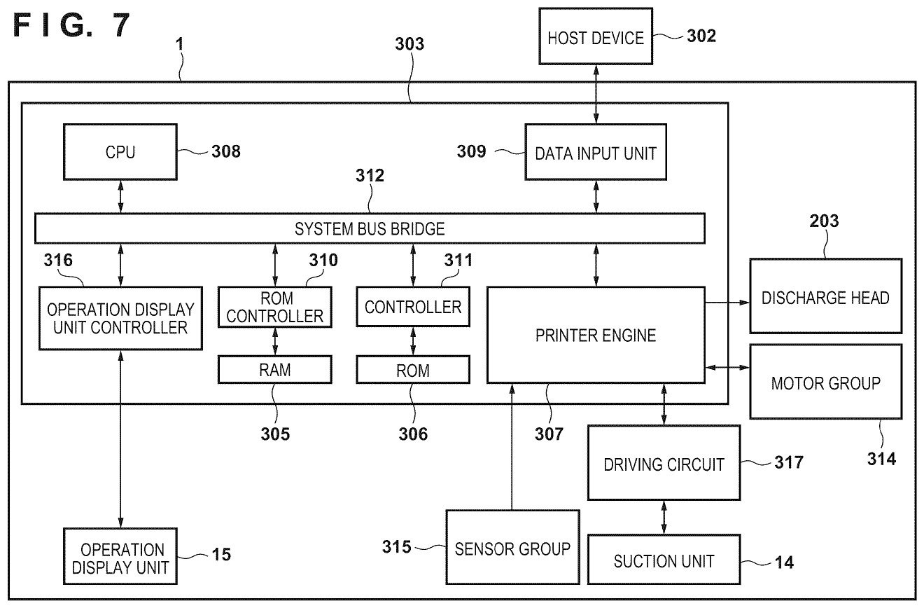

FIG. 7 is a block diagram of a control circuit 303 of the printing apparatus 1. The control circuit 303 is connected to a host device 302. The control circuit 303 includes at least one processor and at least one storage device, and the processor executes a program stored in the storage device. More specifically, the control circuit 303 includes a CPU 308, a printer engine 307, a data input unit 309, a RAM controller 310, a ROM controller 311, and an operation display unit controller 316. These modules of the control circuit 303 are connected to each other via a system bus bridge 312.

The CPU 308 outputs an instruction to each block of the control circuit 303 and controls the whole circuit. The data input unit 309 receives a print job from the host device 302 and deploys the input image data on the RAM 305 via the RAM controller 310. The printer engine 307 receives the data on the RAM 305 via the RAM controller 310, converts it into an image data format to be used in the discharge heads 203, and transmits the converted data to the discharge heads 203 in accordance with information from a sensor group 315. Note that an example of the information from the sensor group 315 is position information of the carriage 201. Also, the sensor group 315 can include, for example, an environment sensor that detects the environment of the place where the printing apparatus 1 is installed. The environment sensor may be a temperature/humidity sensor that detects the temperature and humidity of the place where the printing apparatus 1 is installed.

A ROM 306 stores program data and various kinds of parameters, which are transmitted to the RAM controller or the printer engine via the ROM controller 311. The control circuit 303 may be implemented as an application specific integrated circuit (ASIC) sealed as a system LSI in one package.

The driving circuit 317 drives the electric fan 14a of the suction unit 14. Control of the electric fan 14a can be performed by, for example, not only ON/OFF control but also PWM control. In PWM control, the electric fan 14a can be controlled by a PWM signal from the printer engine 307. For example, when the duty ratio of the PWM signal is close to 100%, the rotation speed of the electric fan 14a can be increased. Reversely, when the duty ratio of the PWM signal is close to 0%, the rotation speed of the electric fan 14a can be decreased. Note that when the duty ratio of the PWM signal is set to 0%, driving of the electric fan 14a can be stopped.

### <Example of Control>

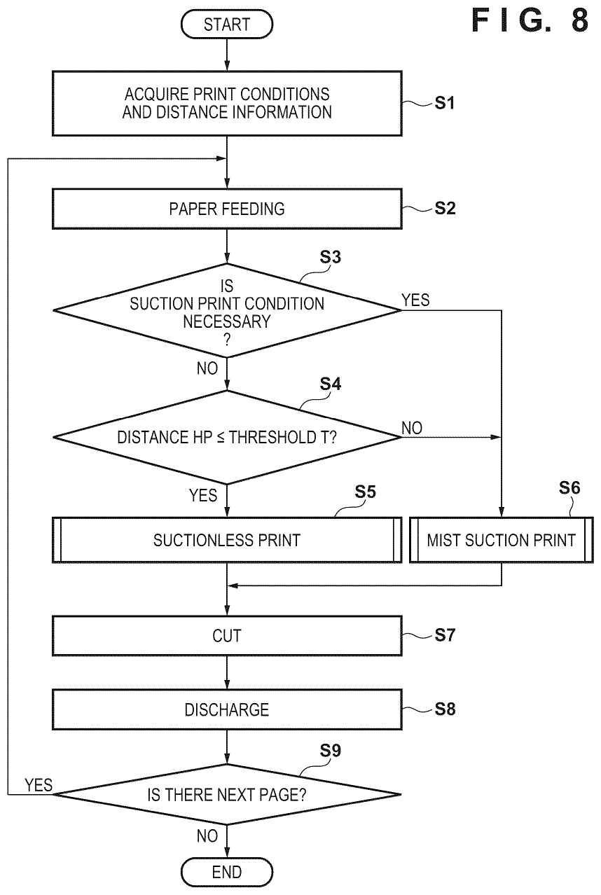

An example of processing executed by the CPU 308 of the control circuit 303 will be described. FIG. 8 is a flowchart showing an example of processing executed by the CPU 308, and is a flowchart of control printing of the printing operation performed upon receiving a print job from the host device 302.

In step S1, print conditions included in the received print job are acquired. In addition, print information indicating the distance HP is acquired from the RAM 305. In step S2, the conveyance roller 208a is driven to perform a paper feeding operation.

In steps S3 and S4, processing of selecting one of suctionless print processing and mist suction print processing as print processing during the printing operation is performed. In these print processes, suction control associated with driving of the suction unit 14 is different. In suctionless print processing, suction of ink mist by the suction unit 14 is not performed during the printing operation. In mist suction print processing, suction of ink mist by the suction unit 14 is performed during the printing operation.

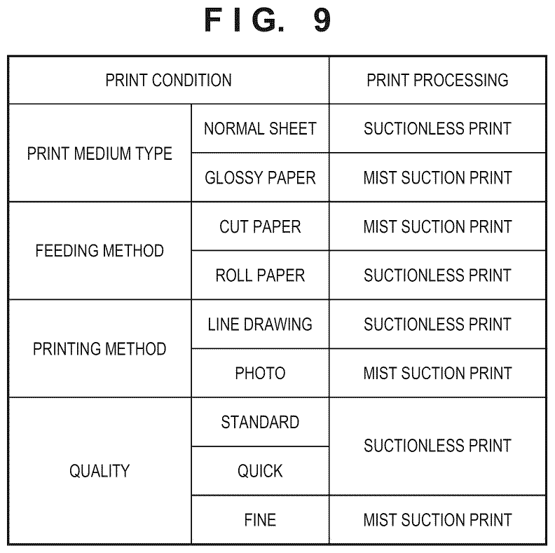

First, in step S3, selection of print processing based on the print conditions acquired in step S1 is performed. FIG. 9 shows an example of the relationship between print conditions and print processing. As the print conditions, four conditions including a type of the print medium 200, a paper feeding method, a printing method (the type of a printed image), and quality are exemplified. “Line drawing” in the printing method is, for example, printing of a drawing of a CAD system. “Photo” is printing of a photo such as a poster. “Quick” and “fine” are conditions associated with the print speed of an image and the resolution of an image. In “quick”, the print speed is high, but the resolution is low. In “fine”, the print speed is low, but the resolution is high. In the example shown in FIG. 9, basically, mist suction print processing is selected for an option having a tendency of increasing the ink emission amount, and suctionless print processing is selected for an option having a tendency of decreasing the ink emission amount.

Referring back to FIG. 7, in a case where mist suction print processing is selected based on any one of the conditions, mist suction print processing is selected for the current print job, and the process advances to step S6. In a case where suctionless print processing is selected based on all the conditions, suctionless print processing is selected for the current print job, and the process advances to step S4.

In step S4, print processing is selected based on the distance information acquired in step S1. If the distance between the discharge head 203 and the print medium 200 is short, the ratio of ink discharged from the discharge head 203 and landing on the print medium 200 is high. On the other hand, if the distance between the discharge head 203 and the print medium 200 is long, the ratio of ink discharged from the discharge head 203 and landing on the print medium 200 is low, and the ink mist generation amount may increase.

In this embodiment, if the distance HP is a certain length, the suction unit 14 is driven. On the other hand, if the distance HP is another length shorter than that, the suction unit 14 is not driven. More specifically, in step S4, if a relationship given by distance HP≤ threshold T holds, the distance H between the discharge head 203 and the print medium 200 is considered as short, suction stop processing is selected, and the process advances to step S5. On the other hand, if a relationship given by distance HP>threshold T holds, the distance H between the discharge head 203 and the print medium 200 is considered as long, mist suction printing is selected, and the process advances to step S6.

In step S5, suctionless print processing is executed. In step S6, mist suction print processing is executed. Details of these processes will be described later.

In step S7, the print medium 200 is cut by the cutting mechanism 213. For example, if roll paper is used as the print medium 200, this is cut. If the print medium 200 need not be cut, the processing of step S7 is skipped. In step S8, the print medium 200 is discharged. In step S9, it is determined whether a next page exists. If a next page exists, the process returns to step S2, and the same processing is repeated. If a next page does not exist, the processing is ended.

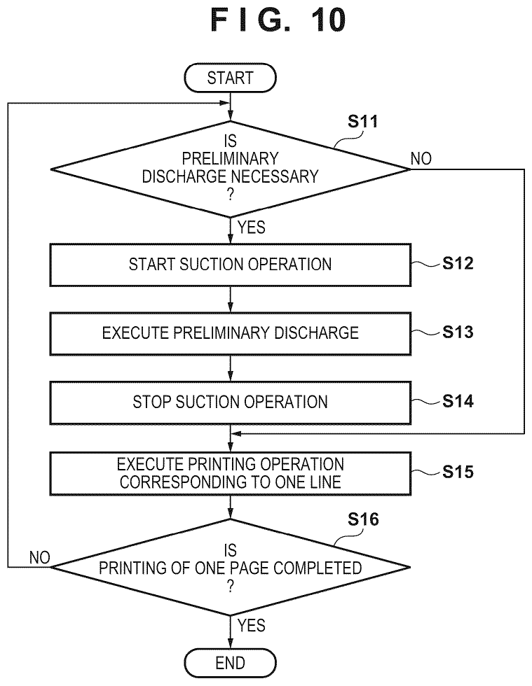

FIG. 10 is a flowchart showing an example of suctionless print processing in step S5. In step S11, it is determined whether preliminary discharge of the discharge heads 203 is necessary in the maintenance unit 214. If preliminary discharge is necessary, the process advances to step S12. If preliminary discharge is unnecessary, the process advances to step S15.

In step S12, a suction operation by the suction unit 14 is started. More specifically, the electric fan 14a is driven. In step S13, the carriage 201 is moved to above the maintenance unit 214, and preliminary discharge of discharging ink from the discharge heads 203 is executed. In the preliminary discharge, ink is discharged from each nozzle of the discharge heads 203, and generation of ink mist tends to be large. For this reason, preliminary discharge is performed during the suction operation by the suction unit 14. When the preliminary discharge is ended, the process advances to step S14, and the suction operation by the suction unit 14 is stopped. More specifically, driving of the electric fan 14a is stopped.

In step S15, a printing operation corresponding to one line is executed. In step S16, it is determined whether printing of one page is completed. If printing is not completed, the process returns to step S11, and the same processing is repeated. If printing is completed, the processing is ended.

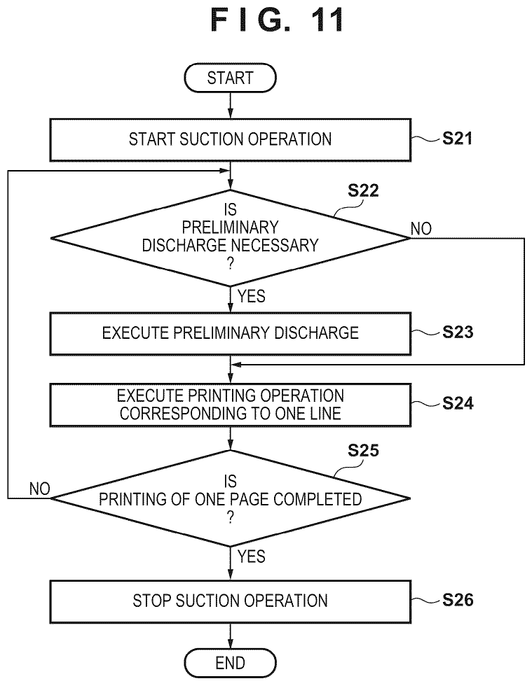

FIG. 11 is a flowchart showing an example of mist suction print processing in step S6. In step S21, the suction operation by the suction unit 14 is started. More specifically, the electric fan 14a is driven. In step S22, it is determined whether preliminary discharge of the discharge heads 203 is necessary in the maintenance unit 214. If preliminary discharge is necessary, the process advances to step S23. If preliminary discharge is unnecessary, the process advances to step S24.

In step S23, the carriage 201 is moved to above the maintenance unit 214, and preliminary discharge of discharging ink from the discharge heads 203 is executed. In step S24, a printing operation corresponding to one line is executed. In step S25, it is determined whether printing of one page is completed. If printing is not completed, the process returns to step S22, and the same processing is repeated. If printing is completed, the process advances to step S26. In step S26, the suction operation by the suction unit 14 is stopped. More specifically, driving of the electric fan 14a is stopped. After that, the processing is ended.

As described above, in this embodiment, when executing the operation of the suction unit 14 in the printing operation, the distance H between the discharge head 203 and the print medium 200 is taken into consideration. Hence, if generation of ink mist increases due to the distance H, this can be removed by the suction unit 14. It is possible to prevent the ink mist from making the print medium 200 dirty or affecting the life of peripheral devices. On the other hand, if generation of ink mist is small, the suction unit 14 is stopped, thereby avoiding wasteful power consumption and reducing energy consumption.

### <Change of Distance HP>

The distance HP can be changed based on various kinds of conditions. For example, the distance HP can be changed in accordance with a user instruction. In some cases, the user wants to change the distance HP to avoid contact between the discharge head 203 and the print medium 200 depending on the thickness or bending of the print medium 200. If the user instructs to increase/decrease the distance HP on the operation display unit 15, the control circuit 303 drives the lift motor 121 and increases/decreases the distance HP in accordance with the instruction.

The distance H may automatically be changed by the control circuit 303. Factors of the change are print conditions or the installation environment of the printing apparatus 1. An example of the print condition is the setting of the thickness of the print medium 200. If the print medium 200 is thick, the distance HP may be long, and if the print medium 200 is thin, the distance HP may be short. Another example of the print condition is the setting of quality. To obtain high quality, the distance HP may be short, and if the quality is normal, the distance HP may be long.

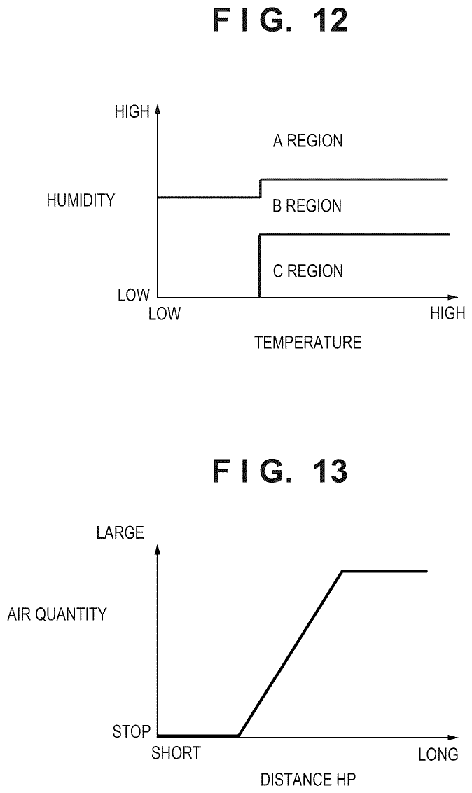

Examples of the installation environment are the temperature and the humidity. The temperature and humidity can be specified from the detection result of the temperature/humidity sensor included in the sensor group 315. FIG. 12 is a view showing an example of the relationship between a temperature/humidity and regions A to C for discriminating the distance HP. The region B is a region where the distance HP is set to a standard length. The region A is a region where the distance HP is set to a relatively long length. The region C is a region where the distance HP is set to a relatively short length. In an environment with a high humidity, since the print medium 200 readily curls, the distance HP is set long to avoid contact between the discharge head 203 and the print medium 200. In an environment with a high temperature, since ink readily dries, the distance HP is set short.

### OTHER EMBODIMENTS

In the above-described embodiment, the presence/absence of suction by the suction unit 14 during the printing operation is switched in accordance with the print conditions or distance information (steps S4 to S6 in FIG. 8). However, the air quantity of the suction unit 14 may be increased/decreased. The air quantity of the suction unit 14 may be increased/decreased by changing the duty ratio of the PWM signal to drive the electric fan 14a. FIG. 13 is a view showing an example of the relationship between the distance HP and the air quantity. In the example shown in FIG. 13, if the distance HP is relatively short, the air quantity is decreased to reduce power consumption, and if the distance HP is long, the air quantity is increased to promote removal of ink mist.

Next, in the above-described embodiment, the print conditions are taken into consideration when selecting one of suctionless print processing and mist suction print processing (step S3 in FIG. 8). However, the selection may be done based on the distance HP without considering the print conditions (step S4 in FIG. 8).

Next, in the above-described embodiment, as the mechanism for changing the distance HP, a mechanism for changing the height of the discharge head 203 has been exemplified. However, it may be a mechanism for changing the height of the platen 209.

Next, in the above-described embodiment, the distance HP is used as the distance information associated with the distance between the print medium 200 and the discharge head 203. However, it may be the distance H. The distance H may be calculated from the distance HP and the information of the thickness of the print medium 200, or may be measured by a sensor. As the sensor for measuring the distance H, for example, the multisensor 122 may be used. If the distance H is used as the distance information, the present disclosure can be applied to an apparatus that does not have a mechanism for changing the distance HP. In this case, since the distance HP is fixed, the distance H varies depending on the thickness of the print medium 200.

Next, in the above-described embodiment, the serial type printing apparatus 1 in which the discharge heads 203 discharge ink while moving along with the movement of the carriage 201 has been exemplified. However, the present disclosure can also be applied to a full line type printing apparatus in which the discharge heads 203 have a length corresponding to the width of the print medium 200.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A printing apparatus comprising:
a discharging unit configured to discharge a liquid to a print medium;
a suction unit configured to suck mist on the print medium;
an acquiring unit configured to acquire information about a distance between the print medium and the discharging unit; and
a suction control unit configured to control driving of the suction unit based on the information acquired by the acquiring unit,
wherein the suction control unit is configured to control presence/absence of driving of the suction unit based on the information.

2. The apparatus according to claim 1, wherein the suction control unit is configured to control an air quantity of the suction unit based on the information.

3. The apparatus according to claim 1, wherein the suction control unit is configured to control driving of the suction unit based on a print condition and the information acquired by the acquiring unit.

4. The apparatus according to claim 3, wherein the suction control unit is configured to control the presence/absence of driving of the suction unit during a printing operation,
if the print condition is a first print condition, the suction unit is driven, and
if the print condition is a second print condition, the presence/absence of driving of the suction unit is controlled based on the information.

5. The apparatus according to claim 3, wherein the print condition is a condition associated with a type of the print medium.

6. The apparatus according to claim 3, wherein the print condition is a condition associated with a resolution of an image.

7. The apparatus according to claim 3, wherein the print condition is a condition associated with a print speed.

8. The apparatus according to claim 1, further comprising a platen configured to face the discharging unit,
wherein the print medium is conveyed between the discharging unit and the platen, and
the information indicates a distance between the platen and the discharging unit.

9. The apparatus according to claim 8, wherein the suction control unit is configured to drive the suction unit if the distance is a first distance, and
not to drive the suction unit if the distance is a second distance shorter than the first distance.

10. The apparatus according to claim 8, wherein the suction control unit is configured to control the suction unit in a first mode if the distance is a first distance, and
to control the suction unit in a second mode if the distance is a second distance shorter than the first distance, and
in the first mode, an air quantity of the suction unit is larger than in the second mode.

11. The apparatus according to claim 8, further comprising a changing unit configured to change the distance.

12. The apparatus according to claim 11, wherein the distance is changed by the changing unit in accordance with an environment where the printing apparatus is installed.

13. The apparatus according to claim 11, wherein, if a humidity of the environment where the printing apparatus is installed is a first humidity, the distance is set to a first distance by the changing unit, and,
if the humidity of the environment where the printing apparatus is installed is a second humidity higher than the first humidity, the distance is set to a second distance longer than the first distance by the changing unit.

14. The apparatus according to claim 11, wherein, if a temperature of the environment where the printing apparatus is installed is a first temperature, the distance is set to a first distance by the changing unit, and,
if the temperature of the environment where the printing apparatus is installed is a second temperature higher than the first temperature, the distance is set to a second distance shorter than the first distance by the changing unit.

15. The apparatus according to claim 11, wherein the distance is changed by the changing unit in accordance with a user instruction.

16. The apparatus according to claim 1, wherein the information indicates a distance of the discharging unit to the print medium.

17. The apparatus according to claim 1, wherein the discharging unit can execute a preliminary discharge operation of discharging the liquid that does not contribute to printing of an image, and
the suction control unit drives the suction unit during the preliminary discharge operation.

18. A printing apparatus comprising:
a discharging unit configured to discharge a liquid to a print medium;
a platen is configured to face the discharging unit; and
a suction unit configured to suck mist on the print medium,
wherein the print medium is conveyed between the discharging unit and the platen,
if a distance between the platen and the discharging unit is a first distance, the suction unit is driven, and,
if the distance between the platen and the discharging unit is a second distance shorter than the first distance, the suction unit is not driven.

19. A printing apparatus comprising:
a discharging unit configured to discharge a liquid to a print medium;
a platen is configured to face the discharging unit; and
a suction unit configured to suck mist on the print medium,
wherein the print medium is conveyed between the discharging unit and the platen, and,
if a distance between the platen and the discharging unit is a first distance, the suction unit makes an air quantity larger than in a case where the distance between the platen and the discharging unit is a second distance shorter than the first distance.
